(19) United States
(12) Patent Application Publication
(10) Pub. No.: US 2013/0032650 A1
(43) Pub. Date: Feb. 7, 2013

(54) METHOD FOR DEPOLYMERISING POLYSACCHARIDES BY MEANS OF MECHANICAL MILLING

(71) Applicants: Claire Boisset, Roscoff (FR); Tinaig Le Costaouec, Larmor Plage (FR); Joelle Cozien, Ploumoguer (FR); Corinne Sinquin, Nantes (FR); Jacqueline Ratiskol, Sainte Luce sur Loire (FR); William Helbert, Roscoff (FR); Gaelle Correc, Santec (FR); Veronique Larreta Garde, L'Isle D'adam (FR)

(72) Inventors: Claire Boisset, Roscoff (FR); Tinaig Le Costaouec, Larmor Plage (FR); Joelle Cozien, Ploumoguer (FR); Corinne Sinquin, Nantes (FR); Jacqueline Ratiskol, Sainte Luce sur Loire (FR); William Helbert, Roscoff (FR); Gaelle Correc, Santec (FR); Veronique Larreta Garde, L'Isle D'adam (FR)

(73) Assignees: CENTRE NATIONAL DE RECHERCHE SCIENTIFIQUE - CNRS, Paris cedex 16 (FR); INSTITUT FRANCAIS DE RECHERCHE POUR L'EXPLOITATION DE LA MER-IFREMER, Issy-les-Moulineaux Cedex (FR); UNIVERSITE PIERRE ET MARIE CURIE (PARIS 6 ), Paris Cedex 05 (FR)

(21) Appl. No.: 13/509,029

(22) PCT Filed: Nov. 29, 2010
(86) PCT No.: PCT/IB2010/003053

§ 371 Date: Jul. 25, 2012

(30) Foreign Application Priority Data
Nov. 27, 2009 (FR) 09 05705

(51) Int. Cl. B02C 19/00

(52) U.S. Cl. 241/25

(57) ABSTRACT

A method for controlled reduction of the weight average molar mass of a polysaccharide down to a lower and determined weight average molar mass, which method includes a step for mechanical milling of the polysaccharide by a ball mill, until the polysaccharide having the desired weight average molar mass is obtained.

This patent application claims priority of the French patent application FR 09/05705 filed on Nov. 27, 2009, which is incorporated to the text of the present patent application by reference.

### FIELD OF THE INVENTION

The present invention relates to the field of depolymerization of polysaccharides and more specifically to a method for depolymerizing polysaccharides by mechanical milling.

### PRIOR ART

Polysaccharides are polymers consisting of oses. These polymers may have very diverse structures notably either including branches or not, or further the presence of organic and/or inorganic constituents. Further, these polysaccharides which have high molecular weights, are most often found in the form of a mixture of oside chains of different sizes.

If these polysaccharides benefit from very widespread possible uses in the food, cosmetic or pharmaceutical fields, the large size of these compounds (which large size is often associated with solubility and/or viscosity problems) is a limitation for a wider use of their properties.

Depolymerization methods have therefore been developed based on chemical, physical and/or enzymatic depolymerization of polysaccharides, for enlarging the spectrum of use of these polysaccharides. As an example, mention may thus be made of depolymerization techniques by irradiation (U.S. Pat. No. 7,259,192), by ultrasonic waves (FR 2 891 831), by radical depolymerization either using a metal catalyst (WO 2006/003289 or WO 2006/003290 respectively) or not or further by enzymatic depolymerization (WO 99/004027).

However, these different techniques have many drawbacks with, for the most effective techniques (chemical and enzymatic techniques), the requirement of resorting to purification and/or freeze-drying steps. These techniques are actually performed on liquid phases and may further generate co-products.

### SUMMARY OF THE INVENTION

The inventors have now developed a novel method for depolymerization by mechanical milling, said method has the following advantages as compared with other methods:
a) Dry application, in the absence of solvents (water, aqueous solvents, organic solvents),
b) High yield (of more than 95%),
c) No purification step after depolymerization,
d) No freeze-drying step,
e) Preservation of the ose composition, i.e. of the oside structure of the polysaccharide,
f) Preservation of the composition in substituents of organic and inorganic type, substituents initially present on the oside structure of the polysaccharide,
g) Obtaining polysaccharides with homogeneous sizes,
h) Obtaining low molecular weight polysaccharides, and
i) No step for stabilizing the final products.

Accordingly, the present invention relates to a method for controlled reduction in the average weight molar mass of a polysaccharide down to a lower and determined weight average molar mass, said method comprises a step for mechanical milling of said polysaccharide by means of a ball mill until the polysaccharide having the desired weight average molar mass is obtained.

The present invention also relates to the use of a ball mill for reducing the weight average molar mass of a polysaccharide down to a lower and determined weight average molar mass.

### DETAILED DESCRIPTION OF THE INVENTION

The depolymerization method developed by the inventors uses a small amount of energy, allows increase in the yield of the final product (close to 100%), does not require any purification steps (gain in time, less equipment and therefore lower cost), and does not require any freeze-drying step (expensive step) since the method may use a dry product.

More specifically, the present invention deals with a method for controlled reduction of the weight average molar mass of a polysaccharide down to a lower and determined weight average molar mass, which method comprises a step for mechanical milling of said polysaccharide by means of a ball mill, until the polysaccharide having the desired weight average molar mass is obtained.

By polysaccharide, is meant a polymer consisting of oses and which may include substituents of an organic type (acetates, pyruvates, succinates, lactates, glycerates, propionates, hydroxybutanoates, etc.) and/or inorganic type (sulfates, phosphates, etc.).

As an example of such polysaccharides, mention may be made of starch, polydextrose, lignocellulose, mannan, chitin, chitosan, cellulose, xylanes, amylopectin, pectins, galactomannans such as guar gum, inulin, glucomannans, xanthans, gellans, alginates, chondroitins, hyaluronans, curdlans, pullulans, succinoglycans, laminarans, alternans, scleroglucans, dextrans, levans, fucans, carrageenans, agars and ulvans and derivatives thereof.

As an example of such derivatives, mention may notably be made of polysaccharides from among those mentioned earlier but further integrating substituents of an organic type and/or inorganic type. One skilled in the art is thus capable of determining, considering his/her general knowledge, the nature of the possible derivatives for a given polysaccharide. For derivatives of cellulose, mention may thus be made of methylcellulose, hydroxyethylcellulose, hydroxypropyl methylcellulose, hydroxypropyl cellulose, carboxymethylcellulose, acetyl cellulose, nitrocellulose, carboxymethyl nitrocellulose, ethylcellulose, cellulose acetate, cellulose acetate butyrate or further cellulose acetate propionate.

Because of the mild depolymerization conditions, the method according to the invention gives the possibility of controlling reduction in the weight average molar mass of the polysaccharide by selecting the milling duration and/or the number and diameter of the balls and by controlling the temperature, and this while preserving their chemical structure.

Biosynthesis of polymers in general most often results in a distribution of chains of different lengths. Thus, it is generally not possible to define a molar mass of a polymer or of a polysaccharide because of this heterogeneity. Therefore, one refers to an average molar mass, Mw, which is expressed in g·mol⁻¹.

For the weight average molar mass Mw, i.e. Mᵢ being the molar mass of species i and Ni representing the number of molecules of species i, the weight average molar mass is equal to:

$$Mw = \frac{{\sum }^{ } Ni \times {Mi}^{2}}{{\sum }^{ } Ni \times Mi}$$

The number average molar mass Mn represents the total mass of all the oside chains in a sample divided by the total number of chains in the sample. Let Mᵢ be the molar mass and Ni the number of chains of mass Mᵢ, the number average molar mass Mn is equal to:

$$Mw = \frac{{\sum }^{ } Ni \times Mi}{{\sum }^{ } Ni}$$

The polydispersity index Ip allows global characterization of the dispersity of the molar masses of a polysaccharide and is equal to:

$$Ip = \frac{Mw}{Mn}$$

With Mw corresponding to the weight average molar mass and Mn corresponding to the number average molar mass as described earlier.

The polydispersity index Ip of a polysaccharide may be simply determined after determining the values of the number (Mn) and weight (Mw) average molar mass by HPSEC coupled with triple detection: light scattering, value of the intrinsic viscosity of the polysaccharide and by refractometry.

There exist many methods well known to one skilled in the art for determining the weight average molar mass of a polysaccharide. As an example of such methods, mention may be made of mass spectroscopy, osmometry, analytic ultra-centrifugation, high performance steric exclusion chromatography or further low angle neutron scattering (LANS), preferably the method used is high performance steric exclusion chromatography.

The different milling parameters to be used in the method according to the invention depend on the polysaccharide to be depolymerized and on the desired degree of depolymerization and may be simply determined by one skilled in the art when considering the examples hereafter.

More specifically, the method according to the invention uses the following parameters:
a) A milling time comprised between one minute and 50 hours, preferably between 30 minutes and 24 hours.
b) A milling temperature comprised between −196° C. and +80° C., preferably between −130° C. and +20° C.
c) A vibration frequency of the ball mill comprised between 3 and 60 Hz (180 to 3,600 rpm), preferably between 20 Hz and 30 Hz (1,200 and 1,800 rpm).
d) The number and diameter of the balls used for the milling, between 1 and 4 balls, preferably between 2 and 3 balls with a diameter comprised between 0.1 mm and 25 mm, preferably between 5 mm and 15 mm.

The method according to the invention further has the advantage of being applied to a polysaccharide in a solid phase, thereby suppressing the requirement of preparing a solution of polymers like in the majority of the depolymerization methods of the prior art, which step is often difficult because of the low solubility of many polysaccharides.

The term of <<solid phase>> as used in the present patent application includes powders, granules, flakes and particles.

The method according to the invention does not comprise any additional purification step. Indeed, the method according to the invention does not require addition of any solvent, salt or metal for initiating depolymerization.

Advantageously, the method according to the invention does not comprise any additional freeze-drying step. Indeed, the method is carried out under dry conditions and the product is collected as a very fine powder.

Still advantageously, the method according to the invention does not comprise any additional step for stabilizing the obtained polysaccharide, for example reduction of the reducing end of a polysaccharide chain in the case of chemical depolymerization via a radical route using a metal catalyst, in order to avoid any uncontrolled initiation of the formation of radicals which may continue the depolymerization action.

The weight average molar mass of the polysaccharide before depolymerization is typically comprised between 3,000,000 and 50,000 g·mol⁻¹.

After depolymerization, the weight average molar mass of the polysaccharide is comprised between 1,000,000 g·mol⁻¹ and 1,000 g·mol⁻¹ and preferably between 500,000 g·mol⁻¹ and 8,000 g·mol⁻¹.

The polysaccharide used has a hydration degree comprised between 0% and 100%, preferably between 10% and 50% and more preferably between 2% and 15%. Depending on the hydration degree of the polysaccharide, the milling temperature is of course adapted so that the polysaccharide is always in a solid phase.

According to a preferred embodiment of the method according to the invention, the polysaccharide obtained after depolymerization has a polydispersity index Ip comprised between 1.1 and 5.

According to a preferred embodiment, the method according to the invention is characterized in that the weight average molar mass of the polysaccharide (g/mol) before depolymerization (A₀), the weight average molar mass of the polysaccharide after depolymerization (Aₜ) and the time (minutes) for milling (t) are selected so that by solving the following equation:

Aₜ=A₀e^{-kt}−200 t+X

wherein
k is a constant comprised between 0.1 and 5, preferably 0.5 and 3, and
X=A₀/k′ with k′ comprised between 1 and 200, preferably between 10 and 100,
it is possible, after depolymerization, to obtain a polysaccharide having the desired weight average molar mass.

The present invention also deals with the use of a ball mill for reducing the weight average molar mass of a polysaccharide down to a lower and determined weight average molar mass.

With this use, it is possible, as this is mentioned earlier, to control the reduction in the weight average molar mass of a polysaccharide by selecting the milling time and/or the number and diameter of the balls and by controlling the temperature, and this while preserving its chemical structure. As regards the polysaccharide used, before and after reduction of its molar mass, the latter polysaccharide is as described earlier. Preferably, the polysaccharide used is thus in a solid phase.

As apparent earlier, the use according to the invention allows reduction in the weight molar mass of a polysaccharide without requiring any additional step for:
purification,
freeze-drying, and/or
stabilization of the obtained polysaccharide.

Other features of the invention will become apparent in the following examples, without however the latter being any limitation of the invention.

### EXAMPLES

### 1) Depolymerizaton with Preservation of the Ose Composition

1-1 Polysaccharides Used

The polysaccharides used for illustrating the method according to the invention are exopolysaccharides produced by mesophilic marine bacteria from a deep hydrothermal medium.

By exopolysaccharides (EPS) is meant a polysaccharide produced by a microorganism and secreted into the medium or present at the surface of the microorganism. More specifically, the two polysaccharides used were derived from the Alteromonas macleodii subsp. fijiensis biovar deepsane (HYD 657) and Vibrio diabolicus (HE 800) species, had polydispersity indexes of 1.5 and an average molecular mass of more than 1,000,000 g/mol in particular from 1,100,000 and 1,750,000 g/mol respectively.

1-2 Depolymerization Method

Two grams of freeze-dried polysaccharide in the form of a powder were placed in a stainless steel bowl with a volume of 20 ml in the presence of two balls with a diameter of 9 mm, also in stainless steel.

The milling was carried out at room temperature with a set vibration frequency of 30 Hz. For each polysaccharide, two tests were conducted.

During the first test, the total milling time was 42 hours with cycles of 90 minutes, in order to allow homogenization of the mixture and cooling of the polysaccharides.

During the second test, the total milling time was 42 hours with cycles of 60 minutes, in order to allow homogenization of the mixture while comprising 5 to 10 minutes for cooling the polysaccharides.

1-3 Tracking the Ose Composition

During both tests described earlier, regular samplings (after 12 h, 24 h, 36 h and 42 h for test 1 and 10 h, 25 h, 35 h and 42 h for test 2) were carried out in order to allow analysis of the polysaccharides in terms of oside composition.

The oside compositions of the native polysaccharides depolymerized by milling were then determined by gas phase chromatography (GPC).

The molar ratio of the monosaccharides present in the native and depolymerized exopolysaccharides is determined after methanolysis of the polysaccharide and silylation in order to make them volatile. They are thus identified and assayed by gas phase chromatography in the form of O-trimethylsilylated methyl glycosides.

The oside composition in molar ratios obtained by GPC of the polysaccharides HYD 657 and HE 800 is shown in tables 1 and 2 respectively.

TABLE 1
Oside composition (molar ratios) of the native EPS HYD 657 and
of its derivatives obtained during two mechanical milling tests

| | Composition of the HYD 657 polysaccharide | | | | | | |
|---|---|---|---|---|---|---|---|
| Nature of the HYD | (in molar ratios) | | | | | | |
| 657 polysaccharide | Fuc | Rha | Glc | Gal | Man | GlcA | GalA |
| native | 1 | 2.5 | 2.6 | 5.9 | 1.4 | 2 | 1.9 |
| 12 h - Test 1 | 1 | 3.1 | 2.4 | 6.2 | 1.3 | 1.7 | 2 |
| 24 h - Test 1 | 1 | 3 | 2.6 | 6.5 | 1.3 | 1.9 | 2.2 |
| 36 h - Test 1 | 1 | 3.1 | 2.3 | 6 | 1.3 | 1.6 | 2 |
| 42 h - Test 1 | 1 | 3 | 2.6 | 6.7 | 1.4 | 2 | 2.2 |
| 10 h - Test 2 | 1 | 3.3 | 1.9 | 5.2 | 1.1 | 1.6 | 1.7 |
| 25 h - Test 2 | 1 | 3.2 | 1.8 | 5.3 | 1.2 | 1.4 | 1.5 |
| 35 h - Test 2 | 1 | 3.2 | 2 | 5.7 | 1.3 | 1.5 | 1.9 |
| 42 h - Test 2 | 1 | 3.1 | 2 | 6 | 1.4 | 1.5 | 1.6 |

Fuc, fucose; Rha, rhamnose; Glc, glucose; Man, mannose; Gal, galactose; GlcA, glucuronic acid; GalA: galacturonic acid.

TABLE 2
Oside composition (molar ratios) of the native EPS HE 800
and of its derivatives obtained during two mechanical milling tests

| | Composition of the HE 800 | | |
|---|---|---|---|
| Nature of the HE 800 | polysaccharide (in molar ratios) | | |
| polysaccharide | GlcNAc | GalNac | GlcA |
| native | 1 | 1.8 | 3.1 |
| 12 h - Test 1 | 1 | 2.1 | 3.3 |
| 24 h - Test 1 | 1 | 2 | 3.1 |
| 36 h - Test 1 | 1 | 2.1 | 3 |
| 42 h - Test 1 | 1 | 2 | 3.1 |
| 10 h - Test 2 | 1 | 1.6 | 2.9 |
| 25 h - Test 2 | 1 | 1.9 | 3.1 |
| 35 h - Test 2 | 1 | 2 | 3 |
| 42 h - Test 2 | 1 | 1.8 | 3.8 |

GlcNAc: N-acetyl glucosamine;
GalNAc: N-acetyl galactosamine;
GlcA: glucuronic acid.

The results show that in spite of their difference in structure and compositions, the depolymerization method does not change the oside composition and chemical structure of both tested polysaccharides over time.

1-4 Tracking the Average Molar Mass and the Polydispersity Index

Parallel with the tracking of the ose composition, the average molar mass and the polydispersity index of the polysaccharides were determined over time.

More specifically, the weight/average molar mass of each of both HE 800 and HYD 657 saccharides was determined by high performance steric exclusion chromatography.

As regards the polydispersity index, Ip=Mw/Mn, the determination of the Mw and Mn values for each polysaccharide is accomplished by steric exclusion chromatography after elution of the exopolysaccharide on a column of the PL-Aquagel-OH type and detection by a 3-angle light scattering detector coupled with a refractometric detector, of the refractive index (RI) and of the value of the intrinsic viscosity of each polysaccharide.

Tables 3, 4, 5 and 6 describe values of average molar masses and of polydispersity index for the HYD 657 and HE 800 polysaccharides during tests 1 and 2.

TABLE 3
Time-dependent change in the weight average molar mass
of polysaccharide chains of HYD 657 as well of the polydispersity
index over time during the first test.

| | Mw | Polydispersity index |
|---|---|---|
| Time (hours) | (g/mol) | (Ip) |
| 0 | 1,100,000 | 1.5 |
| 1.5 | 523,400 | 2.400 |
| 3 | 145,000 | 2.700 |
| 4.5 | 107,000 | 2.663 |
| 6 | 65,150 | 2.198 |
| 7.5 | 57,170 | 2.170 |
| 9 | 57,810 | 2.101 |
| 10.5 | 50,580 | 1.930 |
| 12 | 52,550 | 2.070 |
| 13.5 | 56,800 | 2.364 |
| 15 | 51,460 | 1.802 |
| 16.5 | 48,680 | 1.729 |
| 18 | 36,380 | 1.424 |
| 36 | 38,760 | 1.4 |
| 42 | 33,670 | 1.39 |

TABLE 4
Time-dependent change in the weight average molar mass of
polysaccharide chains of HYD 657 as well as of the polydispersity
index over time during the second test.

| | Mw | Polydispersity |
|---|---|---|
| Time (hours) | (g/mol) | index (Ip) |
| 0 | 1,100,000 | 1.5 |
| 0.25 | 1,116,000 | 3.050 |
| 0.5 | 1,825,000 | 1.365 |
| 0.75 | 1,178,000 | 2.675 |
| 1 | 325,800 | 6.404 |
| 1.25 | 761,800 | 5.689 |
| 1.5 | 624,000 | 4.842 |
| 3 | 198,200 | 4.136 |
| 6 | 57,790 | 1.975 |
| 10 | 64,600 | 2.224 |
| 15 | 25,460 | 1.256 |
| 20 | 28,300 | 1.379 |
| 25 | 25,740 | 1.343 |
| 30 | 22,700 | 1.260 |
| 35 | 32,200 | 1.382 |
| 42 | 24,360 | 1.240 |

TABLE 5
Time dependent change in the weight average molar
mass of polysaccharide chains of HE 800 as well as of
the polydispersity index over time during the first test.

| | | Polydispersity |
|---|---|---|
| Time (hours) | Mw (g/mol) | Index (Ip) |
| 0 | 1,750,000 | 1.22 |
| 1.5 | 213,100 | 2.253 |
| 3 | 150,800 | 2.344 |
| 4.5 | 107,700 | 2.790 |
| 6 | 125,700 | 2.511 |
| 7.5 | 114,900 | 2.393 |
| 9 | 93,100 | 2.353 |
| 10.5 | 107,500 | 2.270 |
| 12 | 112,900 | 2.473 |
| 13.5 | 110,800 | 2.473 |
| 15 | 97,000 | 2.511 |
| 16.5 | 88,630 | 2.548 |
| 18 | 75,310 | 2.349 |
| 19.5 | 88,730 | 2.687 |
| 21 | 71,480 | 2.674 |
| 22.5 | 81,240 | 3.046 |
| 24 | 85,110 | 3.061 |
| 25.5 | 34,360 | 1.612 |
| 27 | 27,450 | 1.373 |
| 28.5 | 23,800 | 1.375 |
| 31.5 | 26,050 | 1.395 |
| 33 | 31,030 | 1.376 |
| 34.5 | 25,380 | 1.287 |
| 36 | 25,830 | 1.283 |
| 37.5 | 24,120 | 1.302 |
| 39 | 17,570 | 1.200 |
| 40.5 | 21,570 | 1.314 |
| 42 | 17,550 | 1.260 |

TABLE 6
Time dependent change in the weight average molar mass
of polysaccharide chains of HE 800 as well as of the
polydispersity index over time during the second test.

| | Mw | Polydispersity |
|---|---|---|
| Time (hours) | (g/mol) | index (Ip) |
| 0 | 1,750,000 | 1.22 |
| 0.25 | 933,800 | 1.435 |
| 0.5 | 924,700 | 1.489 |
| 0.75 | 858,100 | 1.542 |
| 1 | 558,300 | 1.980 |
| 1.25 | 529,800 | 1.903 |
| 1.5 | 500,700 | 1.914 |
| 3 | 324,400 | 2.610 |
| 6 | 283,600 | 2.824 |
| 10 | 157,200 | 3.742 |
| 30 | 57,000 | 2.110 |
| 35 | 17,860 | 1.100 |
| 42 | 21,000 | 1.330 |

The results show that with the method according to the invention, it is possible to achieve depolymerization of the different tested polysaccharides, resulting in the present case, in average molecular masses of 20,000 and 17,000 g/mol upon starting from native polysaccharides with an average molecular mass of 1,100,000 g/mol and of 1,750,000 g/mol respectively. In parallel, the results also show that this depolymerization is obtained with a good value of the polydispersity index in low molecular weight polysaccharides.

Finally, the depolymerized polysaccharides are recovered at the end of the reaction without any additional step and with a yield of the order of 95%.

### 2) Additional Data Obtained by Cold Milling when Using Balls of Different Diameters

Two grams of freeze-dried polysaccharide in the form of a powder were placed in a stainless steel bowl with a volume of 20 ml in the presence of one or more balls of different diameters, also in stainless steel. The milling was carried out by cooling the milling bowl containing the polysaccharide and the balls, with liquid nitrogen. During each test, the total milling times were 7 and 9 hours with cycles of 15 minutes, in order to allow cooling of the mixture with liquid nitrogen. The vibration frequency was set to 30 Hz.

Tables 7, 8, 9, 10 and 11 describe the values of average molar masses and of the polydispersity index for the HYD657 and HE 800 polysaccharides during tests while using either 2 balls of a diameter of 9 mm, or 2 balls of a diameter of 12 mm, or 1 ball of a diameter of 15 mm.

TABLE 7
Time-dependent change in the weight average molar mass of
polysaccharide chains of HE 800 as well as of the polydispersity
index over time during the test while cooling the polysaccharide
and using two balls of 12 mm.

| Time | Mw | |
|---|---|---|
| (hours) | (g/mol) | Ip |
| 0 | 805,000 | 1.258 |
| 0.25 | 321,000 | 2.132 |
| 0.75 | 156,000 | 2.650 |
| 1 | 150,000 | 2.74 |
| 1.25 | 139,000 | 2.94 |
| 1.5 | 132,000 | 3.45 |
| 1.75 | 126,000 | 3.6 |
| 2 | 95,700 | 3.3 |
| 2.25 | 94,200 | 3.30 |
| 2.5 | 94,100 | 2.364 |
| 2.75 | 94,000 | 4.33 |
| 3 | 94,000 | 1.46 |
| 4 | 28,300 | 1.46 |
| 5 | 22,000 | 1.33 |
| 6 | 20,200 | 1.36 |
| 7 | 17,300 | 1.231 |

TABLE 8
Time-dependent change in the weight average molar mass
of polysaccharide chains of HYD 657 as well as of the
polydispersity index over time during the test while cooling
the polysaccharide and using 2 balls of 12 mm

| Time | Mw | |
|---|---|---|
| (hours) | (g/mol) | Ip |
| 0 | 1,600,000 | 1.258 |
| 0.25 | 777,000 | 3.332 |
| 0.5 | 415,000 | 5.93 |
| 0.75 | 284,000 | 3.650 |
| 1 | 178,000 | 3.36 |
| 1.25 | 56,900 | 2.76 |
| 1.5 | 45,000 | 3 |
| 1.75 | 32,600 | 1.73 |
| 2 | 53,000 | 1.9 |
| 2.25 | 48,000 | 2.17 |
| 2.5 | 42,900 | 2 |
| 2.75 | 30,900 | 1.71 |
| 3 | 34,100 | 1.71 |
| 4 | 27,200 | 1.44 |
| 5 | 19,800 | 1.308 |
| 6 | 16,700 | 1.36 |
| 7 | 17,200 | 1.248 |

TABLE 9
Time-dependent change in the weight average molar mass
of polysaccharide chains of HYD 657 as well as of the
polydispersity index over time during the tests while
cooling the polysaccharide and using a ball of 15 mm

| Time | Mw | |
|---|---|---|
| (hours) | (g/mol) | Ip |
| 0 | 1,600,000 | 1.258 |
| 0.25 | 1,510,000 | 3.332 |
| 0.5 | 875,000 | 5.93 |
| 1.25 | 855,900 | 3.36 |
| 1.5 | 775,000 | 2.76 |
| 1.75 | 682,000 | 3 |
| 2 | 492,000 | 1.73 |
| 2.25 | 360,000 | 1.9 |
| 2.5 | 217,000 | 2.17 |
| 3 | 121,000 | 2 |
| 4 | 52,600 | 1.71 |
| 5 | 11,700 | 1.71 |
| 6 | 15,600 | 1.44 |
| 7 | 10,570 | 1.308 |
| 8 | 8,798 | 1.36 |
| 9 | 8,316 | 1.248 |

TABLE 10
Time-dependent change in the weight average molar mass
of the polysaccharide chains of HE 800 as well as of the
polydispersity index over time during the test while cooling
the polysaccharide and using a ball of 15 mm

| Time | Mw | |
|---|---|---|
| (hours) | (g/mol) | Ip |
| 0 | 805,000 | 1.258 |
| 0.25 | 343,000 | 2.132 |
| 0.5 | 202,000 | 2.650 |
| 0.75 | 153,400 | 2.74 |
| 1.25 | 113,900 | 2.94 |
| 1.5 | 119,400 | 3.45 |
| 1.75 | 120,700 | 3.6 |
| 2 | 101,200 | 3.3 |
| 2.25 | 80,500 | 3.30 |
| 2.5 | 70,650 | 2.364 |
| 3 | 61,290 | 4.33 |
| 4 | 24,430 | 1.46 |
| 5 | 20,870 | 1.46 |
| 6 | 17,800 | 1.33 |
| 7 | 19,250 | 1.36 |
| 8 | 16,310 | 1.231 |
| 9 | 15,860 | 1.308 |

TABLE 11
Time dependent change in the weight average molar mass
of polysaccharide chains of HYD 657 as well as of the
polydispersity index over time during the test while cooling
the polysaccharide and using two balls of 9 mm

| | Mw | Polydispersity |
|---|---|---|
| Time (hours) | (g/mol) | index (Ip) |
| 0 | 1,600,000 | 1.25 |
| 0.5 | 1,560,000 | 2.77 |
| 0.75 | 1,180,000 | 3.04 |
| 1 | 830,000 | 3.89 |
| 1.25 | 591,000 | 3.63 |
| 1.5 | 485,000 | 3.59 |
| 1.75 | 389,200 | 3.34 |
| 2 | 339,000 | 3.04 |
| 2.25 | 281,000 | 2.59 |
| 2.5 | 219,000 | 2.66 |
| 2.75 | 192,000 | 2.19 |
| 3 | 196,000 | 2.11 |
| 4 | 179,000 | 2.03 |
| 5 | 179,000 | 2.33 |
| 5.5 | 179,000 | 2.11 |

The results show that with the method according to the invention, it is possible to obtain depolymerization of the different tested polysaccharides resulting, in the present case, in:

(i) average molecular masses of 15,800 and 8,300 g/mol starting from native polysaccharides of an average molecular mass of 805,000 g/mol and of 1,600,000 g/mol, respectively, while using a ball with a diameter of 15 mm for carrying out the milling, over a total period of 9 hours (Tables 9 and 10).

(ii) average molecular masses of 15,800 and 8,300 g/mol starting from native polysaccharides with an average molecular mass of 805,000 g/mol and of 1,600,000 g/mol, respectively, by using a ball with a diameter of 15 mm for carrying out the milling, over a total period of 9 hours (Tables 9 and 10).

(iii) an average molecular mass of 179,000 g/mol starting from a native polysaccharide with an average molecular mass of 1,600,000 g/mol, while using two balls with a diameter of 9 mm for carrying out milling, over a total period of 5 hours 30 mins (Table 11).
Finally, the depolymerized polysaccharides are recovered at the end of the reaction without any additional step and with a yield of the order of 95%.

### 3) Determination of a Mathematical Model Taking into Account the Depolymerization of a Polysaccharide Under Different Conditions

1st test: The starting polysaccharide is the exopolysaccharide of Vibrio diabolicus (HE 800) as described earlier. The milling parameters are the following: Volume of the bowl=20 ml; 2 balls with a diameter of 9 mm, room temperature; set vibration frequency of 30 s⁻¹. T=42 hours with cycles of 90 minutes.

Table 12 describes the values of average molar masses and of polydispersity index during this test.

TABLE 12

| Time (hours) | Mw (g/mol) | Ip |
|---|---|---|
| 0 | 1,750,000 | 1.22 |
| 0.25 | 933,800 | 1.435 |
| 0.5 | 924,700 | 1.489 |
| 0.75 | 858,100 | 1.542 |
| 1 | 558,300 | 1.980 |
| 1.25 | 529,800 | 1.903 |
| 1.5 | 500,700 | 1.914 |
| 3 | 324,400 | 2.610 |
| 6 | 283,600 | 2.824 |
| 10 | 157,200 | 3.742 |
| 30 | 57,000 | 2.110 |
| 35 | 17,860 | 1.100 |
| 42 | 21,000 | 1.330 |

A first analysis shows that this depolymerization reaction does not follow a simple relationship of the first order. The depolymerization kinetics may however be approached by an Ln function wherein the equation is the following: A=A₀e^{-1.8t}−10⁵ Ln t+4·10⁵ with A being the molar mass (g/mol) of the polysaccharide at instant t (in minutes) and A₀ is the initial molar mass (g/mol) of the polysaccharide.

With the equation, it is possible to properly account for the depolymerization and its generalization is verified in a 2^{nd} test.

2^{nd} test: The starting polysaccharide is always the exopolysaccharide of Vibrio diabolicus (HE 800) as described earlier. The milling parameters are the same however with milling cycles of 60 minutes instead of 90 minutes in the 1^{st} test. Table 13 describes the values of average molar masses and of polydispersity index during this 2^{nd} test.

TABLE 13

| Time (hours) | Mw (g/mol) | Ip |
|---|---|---|
| 0 | 1,750,000 | 1.22 |
| 1.5 | 213,100 | 2.253 |
| 3 | 150,800 | 2.344 |
| 4.5 | 107,700 | 2.790 |
| 6 | 125,700 | 2.511 |
| 7.5 | 114,900 | 2.393 |
| 9 | 93,100 | 2.353 |
| 10.5 | 107,500 | 2.270 |
| 12 | 112,900 | 2.473 |
| 13.5 | 110,800 | 2.473 |
| 15 | 97,000 | 2.511 |
| 16.5 | 88,630 | 2.548 |
| 18 | 75,310 | 2.349 |
| 19.5 | 88,730 | 2.687 |
| 21 | 71,480 | 2.674 |
| 22.5 | 81,240 | 3.046 |
| 24 | 85,110 | 3.061 |
| 25.5 | 34,360 | 1.612 |
| 27 | 27,450 | 1.373 |
| 28.5 | 23,800 | 1.375 |
| 31.5 | 26,050 | 1.395 |
| 33 | 31,030 | 1.376 |
| 34.5 | 25,380 | 1.287 |
| 36 | 25,830 | 1.283 |
| 37.5 | 24,120 | 1.302 |
| 39 | 17,570 | 1.200 |
| 40.5 | 21,570 | 1.314 |
| 42 | 17,550 | 1.260 |

The time-dependent change is different from that observed for the 1^{st} test, but always monotonous. By applying the equation developed earlier, a globally satisfactory result is obtained for long times. In order to further test the model, a new test is carried out while varying the milling parameters more extensively.

3rd test: The starting polysaccharide is the exopolysaccharide of Vibrio diabolicus (HE 800) as described earlier but with an average molar mass which is twice lower. The milling parameters are the following: Volume of the bowl=20 ml; 2 balls with a diameter of 12 mm, room temperature, set vibration frequency of 30 s⁻¹. T=7 hours.

Table 14 describes the values of average molar masses and of polydispersity index during this test.

TABLE 14

| Time | Mw | |
|---|---|---|
| (hours) | (g/mol) | Ip |
| 0 | 805,000 | 1.258 |
| 0.25 | 321,000 | 2.132 |
| 0.75 | 156,000 | 2.650 |
| 1 | 150,000 | 2.74 |
| 1.25 | 139,000 | 2.94 |
| 1.5 | 132,000 | 3.45 |
| 1.75 | 126,000 | 3.6 |
| 2 | 957,00 | 3.3 |
| 2.25 | 94,200 | 3.30 |
| 2.5 | 94,100 | 2.364 |
| 2.75 | 94,000 | 4.33 |
| 3 | 94,000 | 1.46 |
| 4 | 28,300 | 1.46 |
| 5 | 22,000 | 1.33 |
| 6 | 20,200 | 1.36 |
| 7 | 17,300 | 1.231 |

This time, the developed model does not account for the depolymerization rate. A calculation of the initial rate shows a rate constant k=3.6. Taking into account the observed changes, the equation of the model is changed to A=A₀ e^{-3,6t}−105 Ln (t)+200,000. The fit is better and is tested in an additional test.

4^{th} test: The starting polysaccharide is the exopolysaccharide of Vibrio diabolicus (HE 800) as described in the 3^{rd} test. The milling parameters are changed once again and a single ball with a diameter of 15 mm and a milling period of 6 hours are used. Table 15 describes the values of average molar masses and of polydispersity index during this 4^{th} test.

TABLE 15

| | Mw | |
|---|---|---|
| Time (hours) | (g/mol) | Ip |
| 0 | 805,000 | 1.258 |
| 0.25 | 343,000 | 2.132 |
| 0.5 | 202,000 | 2.650 |
| 0.75 | 153,400 | 2.74 |
| 1.25 | 113,900 | 2.94 |
| 1.5 | 119,400 | 3.45 |
| 1.75 | 120,700 | 3.6 |
| 2 | 101,200 | 3.3 |
| 2.25 | 80,500 | 3.30 |
| 2.5 | 70,650 | 2.364 |
| 3 | 61,290 | 4.33 |
| 4 | 24,430 | 1.46 |
| 5 | 20,870 | 1.46 |
| 6 | 17,800 | 1.33 |
| 7 | 19,250 | 1.36 |
| 8 | 16,310 | 1.231 |
| 9 | 15,860 | 1.308 |

The obtained results are well consistent with the model developed between 1 h 30 mins and 6 h 30 mins of milling. BEYOND this milling time the values obtained with the model diverge from those observed with the milling machine.

Also, and on the basis of these results, a new model was developed, which is the following: A=A₀ e^{-1,8t}+5 000 (tₘₐₓ−t)−500 t+X wherein A and A₀ respectively correspond to the molar mass (g/mol) at instant t (in minutes) and to the initial molar mass of the polysaccharide, t is the milling time in minutes and X corresponds to A₀/40.

This last model is tested on depolymerization experiments carried out earlier and show very good predictiveness in spite of the differences in masses at the origin (1 to 2) and in spite of the initial differences in rates (1 to 2). In order to test the generalizability of the model, the latter is tested on the exopolysaccharide of Alteromonas macleodii (HYD 657).

### 4) Optimization of the Mathematical Model

1st test: The starting polysaccharide is the exopolysaccharide of Alteromonas macleodii (HYD 657). The milling parameters are the following: Volume of the bowl=20 ml; 2 balls with a diameter of 9 mm, room temperature; set vibration frequency of 30 s⁻¹. T=42 hours with cycles of 90 minutes.

Table 16 describes the values of average molar masses and of polydispersity index during this test.

TABLE 16

| | Measured Mw | Estimated Mw |
|---|---|---|
| Time (hours) | g/mol) | (g/mol) |
| 0 | 1,100,000 | 1,100,000 |
| 1 | 325,800 | 416,329 |
| 3 | 198,200 | 228,468 |
| 6 | 57,790 | 207,022 |
| 10 | 64,600 | 185,000 |
| 15 | 25,460 | 157,500 |
| 20 | 28,300 | 130,000 |
| 25 | 25,740 | 102,500 |
| 30 | 22,700 | 75,000 |
| 35 | 32,200 | 47,500 |
| 42 | 24,360 | 9,000 |

It emerges from this experiment that the fit is not very good between the measured and estimated time-dependent change in the average molar mass of the polysaccharide for short times and the calculated values are too small for long times. For the following experiments repeating the parameters of Tests 2, 3 and 4 but with the exopolysaccharide of Alteromonas macleodii (HYD 657), it emerges that a change in the equation by varying the constant k and by using a variable x equal to A₀/80 is more adequate.

Finally, the modified equation gives the possibility of better accounting for the depolymerization of the two tested polysaccharides versus time, said equation is the following:

Aₜ=A₀e^{-kt}−200 t+X wherein:
A₀ is the initial molar mass (g/mol) of the polysaccharide,
Aₜ is the molar mass (g/mol) of the polysaccharide at time t,
t is the milling time in minutes,
k is a constant comprised between 0.5 and 3 depending on the conditions and
X corresponds to A₀/k′ with k′ comprised between 10 and 100.

1. A method for controlled reduction in the weight average molar mass of a polysaccharide down to a lower and determined weight average molar mass, comprising a step for mechanical milling of said polysaccharide by means of a ball mill, and characterized in that the weight average molar mass of the polysaccharide before depolymerization (A₀), the weight average molar mass of the polysaccharide after depolymerization (Aₜ) and the milling time (t) are selected so that by solving the following equation:
Aₜ=A₀e^{-kt}−200 t+X wherein
k is a constant comprised between 0.1 and 5, preferably 0.5 and 3, and
X=A₀/k′ with k′ comprised between 1 and 200, preferably between 10 and 100,
it is possible to obtain after depolymerization a polysaccharide having the desired weight average molar mass.

2. The method according to claim 1, characterized in that the polysaccharide is a polymer consisting of oses selected from the group comprising starch, polydextrose, lignocellulose, mannan, chitin, chitosan, cellulose, xylanes, amylopectin, pectins, galactomannans like guar gum, inulin, glucomannans, xanthans, gellans, alginates, chondroitins, hyaluronans, curdlans, pullulans, succinoglycans, laminarans, alternans, scleroglucans, dextrans, levans, fucans, carrageenans, agars and ulvans and derivatives thereof.

3. The method according to claim 1, characterized in that said method is applied to a polysaccharide in the solid phase.

4. The method according to claim 1, characterized in that the weight average molar mass of the polysaccharide before depolymerization is typically comprised between 3,000,000 and 30,000 g·mol⁻¹.

5. The method according to claim 1, characterized in that the weight average molar mass of the polysaccharide after depolymerization is comprised between 500,000 g·mol⁻¹ and 8,000 g·mol⁻¹, preferably between 1,000,000 g·mol⁻¹ and 1,000 g·mol⁻¹.

6. The method according to claim 1, characterized in that said method does not comprise any additional purification step.

7. The method according to claim 1, characterized in that said method does not comprise any additional freeze-drying step.

8. The method according to claim 1, characterized in that said method does not comprise any additional step for stabilization of the obtained polysaccharide.

9. The method according to claim 1, characterized in that said polysaccharide has a hydration degree comprised between 0% and 100%, preferably between 10% and 50% and more preferably between 2% and 15%.

10. The method according to claim 1, characterized in that the obtained polysaccharide after depolymerization has a polydispersity index comprised between 1.1 and 5.
